(19) United States
(12) Patent Application Publication
(10) Pub. No.: US 2025/0166239 A1
(43) Pub. Date: May 22, 2025

(54) METHOD AND APPARATUS OF IMAGE PROCESSING, ELECTRONIC DEVICE, AND STORAGE MEDIUM

(71) Applicant: Beijing Zitiao Network Technology Co., Ltd., Beijing (CN)

(72) Inventor: Jiabin Huang, Beijing (CN)

(21) Appl. No.: 18/725,698

(22) PCT Filed: Dec. 26, 2022
(86) PCT No.: PCT/CN2022/141793

§ 371 Date: Nov. 15, 2024

(30) Foreign Application Priority Data
Dec. 29, 2021 (CN) 202111644063.7

(51) Int. Cl. G06T 11/00; G06T 5/20; G06T 7/11; G06T 7/70; G06V 10/44; G06V 10/60; G06V 20/40

(52) U.S. Cl. CPC G06T 11/00; G06T 5/20; G06T 7/11; G06T 7/70; G06V 10/443; G06V 10/60; G06V 20/40; G06T 2207/10016; G06T 2207/20028; G06T 2207/20081; G06T 2207/30244

(57) ABSTRACT

The disclosure provides a method and apparatus of image processing, an electronic device, and a storage medium. The method of image processing includes: obtaining a video frame to be processed and determining a target normal map of the video frame to be processed; determining, based on the target normal map and preset attribute information of a light source, target lighting intensity information of at least one pixel of the video frame to be processed; and determining display information of the at least one pixel based on the target lighting intensity information of the at least one pixel, and determining, based on the display information, a target video frame corresponding to the video frame to be processed.

### CROSS-REFERENCE TO RELATED APPLICATION(S)

The disclosure claims the priority to Chinese Patent Application No. 202111644063.7, filed with the Chinese Patent Office on Dec. 29, 2021, which is incorporated herein in its entirety by reference.

### FIELD

The disclosure relates to the technical field of image processing, and relates to, for example, a method and apparatus of image processing, an electronic device, and a storage medium.

### BACKGROUND

As network technology develops, increasing application programs including a series of software for shooting short videos win high popularity.

When a corresponding video or image is shot with such software, effects are generally added to users in video frames, which can enrich contents displayed in the video frame, and further improve user experience.

When the effect is added to a target object, a target normal map corresponding to the target object needs to be determined at first through end-to-end training based on deep learning. That is, a model is trained with paired normal data, and then a normal map of each video frame is determined with this model.

However, in this method, it is extremely difficult to obtain the paired normal data since a camera with depth information is required for collecting information of objects in an actual scenario. Besides, collected data may have poor quality due to errors and precision of the device, resulting in inaccuracy of a trained model. Mass data that can be collected through different collection devices intend to be inconsistent since these devices vary from one another. Finally, even if data collection is free of problems, it is time consuming to perform model-based reasoning since deployment of a deep learning model is limited to hardware environment. Thus, low input resolution and a small size of the model are usually set for accelerating reasoning, which influences quality of output results to some extent, and results in time consumption and poor added effects particularly for an effect algorithm in a mobile terminal scenario.

### SUMMARY

The disclosure provides a method and apparatus of image processing, an electronic device, and a storage medium, which determine a normal map based on a mobile terminal, and thus improve convenience of determination of the normal map, and further improve of universality of an effect added.

In a first aspect, the disclosure provides a method of image processing. The method includes:
obtaining a video frame to be processed and determining a target normal map of the video frame to be processed;
determining, based on the target normal map and preset attribute information of a light source, target lighting intensity information of at least one pixel of the video frame to be processed; and
determining display information of the at least one pixel based on the target lighting intensity information of the at least one pixel, and determining, based on the display information, a target video frame corresponding to the video frame to be processed.

In a second aspect, the example of the disclosure further provides an apparatus of image processing. The apparatus includes:
a normal map determination module configured to obtain a video frame to be processed and determine a target normal map of the video frame to be processed;
a lighting intensity determination module configured to determine, based on the target normal map and preset attribute information of a light source, target lighting intensity information of at least one pixel of the video frame to be processed; and
a target video frame display module configured to determine display information of the at least one pixel based on the target lighting intensity information of the at least one pixel, and determine, based on the display information, a target video frame corresponding to the video frame to be processed.

In a third aspect, the disclosure further provides an electronic device. The electronic device includes:
one or more processors; and
a memory storing one or more programs, where
the one or more processors, when executing the one or more programs, are caused to implement the method of image processing described above.

In a fourth aspect, the disclosure further provides a storage medium. The storage medium includes computer-executable instructions which, when executed by a computer processor, implement the method of image processing described above.

In a fourth aspect, the disclosure further provides a computer program product. The computer program product includes: a computer program embodied on a non-transitory computer-readable medium, where the computer program includes program codes configured to implement the method of image processing described above.

### BRIEF DESCRIPTION OF THE DRAWINGS

FIG. 1 is a schematic flowchart of a method of image processing according to Example 1 of the disclosure;

FIG. 2 is a schematic flowchart of another method of image processing according to Example 1 of the disclosure;

FIG. 3 is a schematic diagram of determining a target normal map according to Example 1 of the disclosure;

FIG. 4 is a schematic structural diagram of an apparatus of image processing according to Example 2 of the disclosure; and

FIG. 5 is a schematic structural diagram of an electronic device according to Example 3 of the disclosure.

### DETAILED DESCRIPTION OF EMBODIMENTS

Examples of the disclosure will be described below with reference to accompanying drawings Although some examples of the disclosure are shown in the accompanying drawings, the disclosure can be implemented in various forms, and these examples are provided for understanding the disclosure. The accompanying drawings and the examples of the disclosure are merely illustrative.

A plurality of steps described in a method embodiment of the disclosure can be executed in different orders and/or in parallel. Further, the method embodiment can include an additional step and/or omit a shown step, which does not limit the scope of the disclosure.

As used herein, the terms “comprise” and “include” and their variations are open-ended, that is, “comprise but not limited to” and “include but not limited to”. The term “based on” indicates “at least partially based on”. The term “an example” indicates “at least one example”. The term “another example” indicates “at least one another example”. The term “some examples” indicates “at least some examples”. Related definitions of other terms will be given in the following description.

The concepts such as “first” and “second” mentioned in the disclosure are merely used to distinguish different apparatuses, modules or units, rather than limit an order or interdependence of functions executed by these apparatuses, modules or units.

Modifications with “a”, “an” and “a plurality of” mentioned in the disclosure are schematic rather than limitative, and should be understood by those skilled in the art as “one or more” unless otherwise indicated in the context.

Names of messages or information exchanged among a plurality of apparatuses in the embodiment of the disclosure are merely used for illustration rather than limitation to the scope of the messages or information.

Before introducing a technical solution, an application scenario can be illustratively described at first. The technical solution of the disclosure may be applied to any picture requiring effect display, for example, to a process of shooting a video. After video shooting is completed, a corresponding effect may be added to each video frame in a video. Alternatively, every time a video frame is shot, the video frame may be uploaded to a server. Then, the server processes the video frame, and adds a corresponding effect accordingly. In this technical solution, the added effect may be a lamplight effect. When lamplight lights a target object in a video frame to be processed, information may be displayed. The lamplight effect may be an effect scenario created based on light emitted by a virtual light source.

This technical solution may be implemented by the server or a client, or through cooperation between the client and the server. For example, a corresponding video frame is shot by the client, and processed by the client, and then a corresponding effect is added to the video frame. Alternatively, the video frame shot is uploaded to the server, processed by the server, and then sent downstream to the client, and the client displays the video frames to which the effect is added.

### Example 1

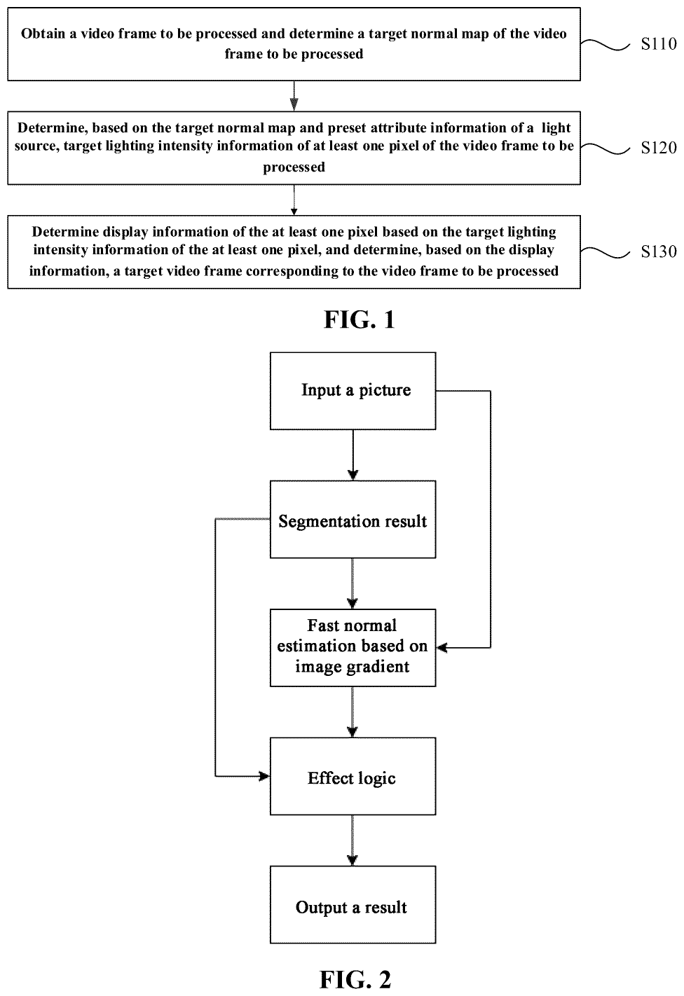

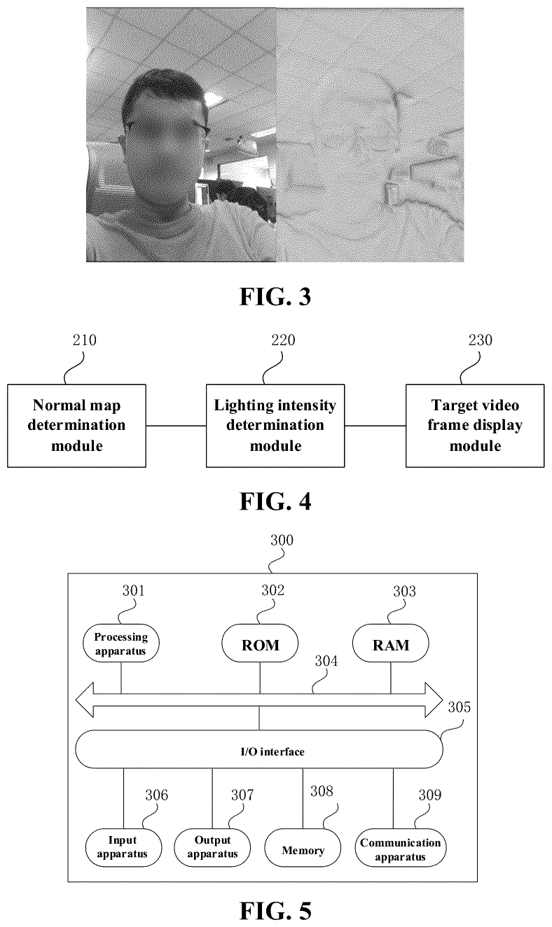

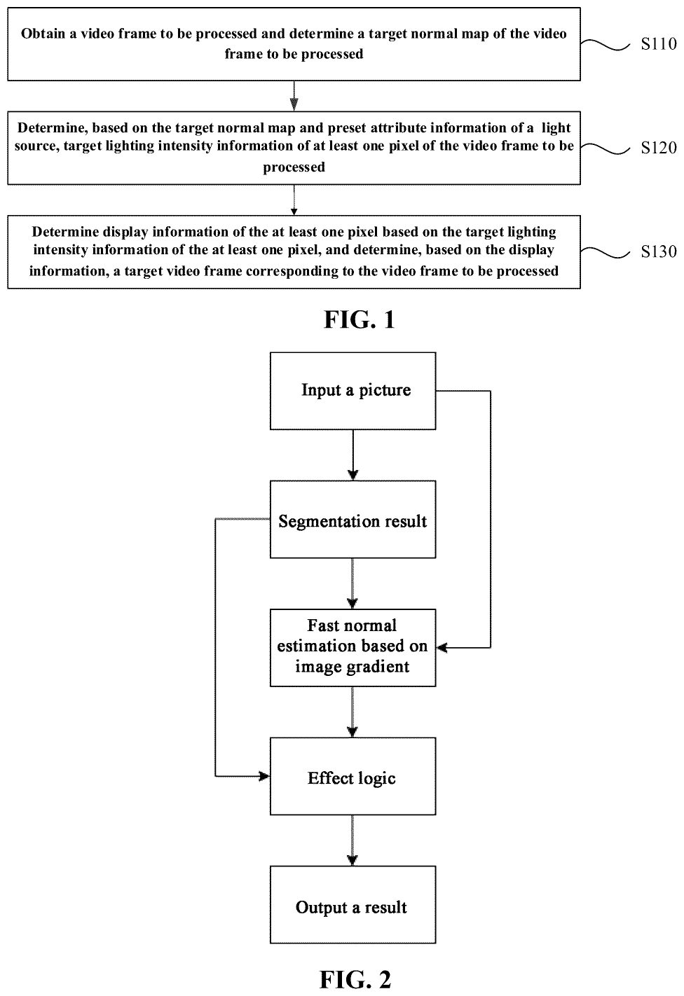

FIG. 1 is a schematic flowchart of a method of image processing according to Example 1 of the disclosure. The example of the disclosure is applied to a situation that a corresponding effect is added to a video frame in any image display scenario supported by the Internet. This method may be implemented through an apparatus of image processing. This apparatus may be implemented in the form of software and/or hardware, for example, an electronic device. The electronic device may be a mobile terminal or a personal computer (PC) terminal, a server, etc. Any image display scenario is usually implemented through cooperation between a client and the server. The method according to this example may be executed by the server, the client or the client cooperating with the server.

S110. A video frame to be processed is obtained and a target normal map of the video frame to be processed is determined.

The apparatus for executing the method of image processing according to the example of the disclosure may be integrated into application software that has a function of processing each video frame in the video. The software may be installed in the electronic device. For example, the electronic device may be the mobile terminal, the PC terminal, etc. The application software may be software of one type that processes the image or video as long as the image or video can be processed, which will not be repeated one by one herein.

The technical solution may be implemented by the client or the server in a case that each video frame in the video is processed after video shooting is completed and then is sent to the client for being displayed, or a case that video frames received are processed in turn during the video shooting.

The video frame currently received by the client or the server may be taken as a current video frame. Alternatively, the client or the server receives a target video and sequentially process video frames in the target video, and the video frame currently being processed may be taken as the current video frame. A normal map corresponding to the video frame to be processed is taken as the target normal map.

In order to determine universality of the target normal map, that is, applicability to the mobile terminal, a normal map determination method adopted in this technical solution may be used to process the target normal map.

In this example, a target normal map of an entire image may be determined. When an added effect is usually added to an entire body of a target object, or a target effect is added to a part of the target object, an entire normal map corresponding to the target object or a partial normal map of the target object may be determined.

In a first embodiment, at least one video frame to be processed is sequentially obtained from a target video. Gradient information, in a first direction and a second direction, of at least one pixel of the video frame to be processed are determined to obtain normal information of the at least one pixel. The target normal map is obtained based on the normal information of the at least one pixel.

The target video may be a video to be processed by the mobile terminal. Each video frame in the target video may be taken as the video frame to be processed. Each pixel has corresponding normal information. The normal information may include the gradient information in the first direction and the second direction. The first direction may be a horizontal direction and the second direction may be a perpendicular direction. Based on the normal information of each pixel, the target normal map corresponding to the video frame to be processed may be determined. In this case, each pixel in the target normal map has gradient information in two directions.

A normal map determination algorithm may be used to determine the gradient information of each pixel in the video frame to be processed, and then the target normal map of the video frame to be processed is obtained.

In a second embodiment, the video frame to be processed is obtained, and based on a pre-trained image segmentation model, a target segmentation region corresponding to the video frame to be processed is determined. Gradient information, in a first direction and a second direction, of at least one pixel in the target segmentation region are determined to obtain normal information of the at least one pixel, and based on the normal information, the target normal map of the video frame to be processed is determined.

The image segmentation model is a pre-trained neural network model. An input into the image segmentation model may be the current video frame, and an output from the model may be a portrait segmentation result corresponding to the current video frame, that is, a segmented sub-image to be processed. The image segmentation model is the neural network, and this network may be in a structure of visual geometry group network (VGG), residual networks (ResNet), GoogleNet, MobileNet, ShuffleNet, etc. For different network structures, computation amounts of different network structures vary. It can be understood that not all models are lightweight. That is, some models that have a large computation amount are not suitable to deploy on the mobile terminal. A model that has a small computation amount, high computation efficiency and simplicity is easier to deploy on the mobile terminal. If this technical solution is implemented based on the mobile terminal, a model structure of MobileNet or ShuffleNet may be used. According to a principle of the model structure, traditional convolution is changed into separable convolution, that is, depthwise convolution and point-wise convolution, in order to reduce the computation amount. In addition, inverted residuals are used to improve a feature extraction capacity of depthwise convolution. In addition, a simple operation of a shuffle channel is also used to improve an expression capacity of the model. Basic module design of the model is described above, and the model is basically formed by stacking the above modules. This type of model is less time-consuming in reasoning, and may be applied to a terminal with a high time-consuming requirement. Any one of the neural networks described above may be used on a server as long as portrait segmentation of the video frame can be implemented, and then the segmented sub-image to be processed as the portrait segmentation result is obtained. The image segmentation model is merely described above, but not limited thereto. A region to which an effect is added in the video frame to be processed may be determined in advance. Alternatively, it is determined in advance that an effect is added to the target object in the video frame to be processed, and then a region corresponding to the target object is the target segmentation region. After the target segmentation region is determined, the gradient information of each pixel in the target segmentation region may be determined. Based on the normal information of each pixel, the target normal map of the video frame to be processed is determined.

Illustratively, the image segmentation model is configured to segment a user image in the video frame. With reference to FIG. 2, after the video frame to be processed is received, the video frame to be processed is segmented based on the image segmentation model set in a terminal device, and a target user in the video frame to be processed is obtained. Based on fast normal estimation of an image gradient, a normal map corresponding to the target user in the video frame to be processed may be determined, and this normal map may be taken as the target normal map. Reference may be made to FIG. 3 for an effect of the target normal map.

In this example, the step that gradient information, in a first direction and a second direction, of at least one pixel are determined to obtain normal information of the at least one pixel includes: the video frame to be processed is filtered via joint bilateral filtering to obtain a video frame to be used. Gradient information, in the first direction and the second direction, of each pixel in the video frame to be used are determined using a Sobel operator, and the normal information of the at least one pixel is determined.

The target normal map is determined, such that a related effect may be implemented based on the normal information.

Illustratively, when a corresponding scenario is shot based on the mobile terminal, a camera may usually be used. A sensor in the camera may obtain, due to environmental influence, corresponding background noise in the video frame to be processed. However, this type of noise does not belong to a content of the image content, and may be filtered, and then the normal information of the image is accurately estimated. The image noise is mainly filtered out via joint bilateral filtering. This method can filter the noise in the image, and can further preserve edge information in the image. The edge information is important for normal estimation of the video frame to be processed, that is, the joint bilateral filtering can filter out the noise and keep the edge information completely. After filtering, a Sobel operator may be used to determine the normal information of each pixel in the video frame to be processed. In simple terms, this algorithm may compute two pieces of gradient information in the horizontal and the perpendicular direction of the image, and the gradient information include positive and negative types. The gradient information physically denotes a probability of an edge of the pixel. The positive and negative attributes of the gradient information may denote a direction of the pixel. In this case, the normal information, in the horizontal direction and the perpendicular direction, of the corresponding pixel may be obtained. An effect diagram may be seen in FIG. 3.

S120. Based on the target normal map and preset attribute information of a light source, target lighting intensity information of at least one pixel of the video frame to be processed is determined.

A light source effect may be added to the video frame to be processed. That is, after a light source lights a position of determining the target normal map in the video frame to be processed, a corresponding effect may be displayed. The effect displayed corresponds to position information of the light source and the normal information of the pixel. The attribute information of the light source may be the position information of the light source. When the light source lights the target normal map, a light intensity of each pixel may be determined based on the normal information of the pixel. The light intensity determined at this time may be used as the target lighting intensity information.

The light source position information of a target light source may be obtained, and the target lighting intensity information of each pixel may be determined based on the position information of the light source and the normal information of each pixel in the target normal map.

In this example, merely the pixel whose normal information is determined in the video frame to be processed may be processed, so as to determine the target lighting intensity information of the pixel.

The step that based on the target normal map and preset attribute information of a light source, target lighting intensity information of at least one pixel of the video frame to be processed is determined includes: target normal information corresponding to a current pixel in the target normal map is determined for each of the at least one pixel, and target lighting intensity information of the current pixel is determined based on the target normal information, the attribute information of the light source and shooting angle information of a video frame to which the current pixel belongs.

Each pixel in the video frame to be processed is processed in the same method. Determination of target lighting intensity information of one pixel is taken as an example, and the pixel currently introduced is taken as the current pixel.

The normal information corresponding to the current pixel is taken as the target normal information. The attribute information of the light source includes the position information and/or light angle information of the light source. The shooting angle information may be a relative shooting angle between a camera device and the current pixel when the video frame to be processed is shot.

The target normal information of the current pixel may be determined. The target lighting intensity information of the current pixel may be determined based on the target normal information, the lighting intensity information, the position information of the light source and the shooting angle information.

In this example, the attribute information of the light source includes position information of the light source, and the step that target lighting intensity information of the current pixel is determined based on the target normal information, the attribute information of the light source and shooting angle information of a video frame to which the current pixel belongs includes: light direction information of the current pixel is determined based on the position information of the light source. A diffuse lighting value of the current pixel is determined based on the light direction information, the target normal information and a preset diffuse coefficient. A target reflection angle is determined based on the light direction information and the target normal information, and a reflection intensity value of the current pixel is determined based on the target reflection angle, the shooting angle information and a preset reflection coefficient. The target lighting intensity information is determined based on the diffuse lighting value, the reflection intensity value, and an ambient lighting intensity value corresponding to the attribute information of the light source.

A lighting effect method used in this technical solution may be implemented by Phong lighting model. The Phong lighting model is mainly characterized by three components: ambient lighting, a diffuse lighting value and a specular lighting value. The ambient lighting may refer to that even in the dark, there is usually some light in the world (moon, distant light), and an object is almost never completely dark accordingly. In order to simulate this effect, an ambient lighting constant may be used, and refers to that some light information is always given to the object. The diffuse lighting may refer to simulation of the directional impact of a light source on the object. The diffuse lighting is the most significant visual component in the Phong lighting model. When a part of the object tends towards the light source, the part will be brighter. The specular lighting in another dimension may refer to simulation of a bright spot on a shiny object. A color of the specular lighting will be closer to a color of light relative to a color of the object. The target lighting intensity information of each pixel may be determined based on the information described above.

The position information of the light source may be denoted by world coordinates. The light direction information may be expressed by a relative angle. By computing a value between the world coordinates of the current pixel and coordinates of a light source position, the light direction information corresponding to the current pixel may be determined. The diffuse coefficient, the reflection coefficient, and the ambient lighting amount information are preset. The target reflection angle may be an angle obtained after the light source lights the current pixel and is reflected by the normal information of the current pixel.

That is, a pixel position of the current pixel is denoted by pos, the position information of the light source is denoted by light_pos, and the shooting angle of the shooting device is denoted by viewpos. The light direction information lightDir is determined based on the position information light_pos of the light source and the pixel position pos of the current pixel. The light direction information of a light source corresponding to the current pixel may be determined by a cosine computation method. Then, a similarity (a scalar product of norm and lightDir) between the normal information norm of the current pixel and the light direction information lightDir is computed, and a median is determined. Based on the median and the diffuse intensity coefficient a1, that is, the diffuse coefficient, a final diffuse lighting value of the current pixel is obtained. A corresponding reflection angle reflectDir is computed with the target normal information norm of the current pixel as a central axis and a light direction light_pos as an incident ray. Based on an approximate value of the reflection angle reflectDir computed and the shooting angle viewDir (viewPos-pos), the closer the approximate value is, the stronger specular reflection is. This approximate value is multiplied by the specular lighting coefficient a2, and a final reflection intensity value is obtained, that is, the specular reflection intensity value. Based on a maximum of the ambient lighting, the diffuse lighting value and the reflection intensity value, the target lighting intensity information of the current pixel is determined.

The step that the target lighting intensity information is determined based on the diffuse lighting value, the reflection intensity value, and an ambient lighting intensity value corresponding to the attribute information of the light source includes: the target lighting intensity information is determined as a maximum of the diffuse lighting value, the reflection intensity value and the ambient lighting intensity value.

The maximum determined above of the three values may be used as the target lighting intensity information of the current pixel.

S130. Display information of the at least one pixel is determined based on the target lighting intensity information of the at least one pixel, and based on the display information, a target video frame corresponding to the video frame to be processed is determined.

The step that display information of the at least one pixel is determined based on the target lighting intensity information of the at least one pixel includes: the display information of the at least one pixel is updated based on the target lighting intensity information and corresponding pixel value information of the at least one pixel.

Each pixel in the video frame to be processed has a color value corresponding thereto, and a brightness value of the corresponding pixel may be updated based on the target lighting intensity information. Then, the corresponding pixel in the video frame may be updated based on the brightness value updated and the color value of the corresponding pixel.

According to the technical solution of the example of the disclosure, from output of the segmentation result to output of the final effect, drawing may be performed by using the open graphics library (OpenGL) with a high speed. In addition, a drawing region is limited to a segmented region, and computation is not performed in other regions, thus greatly shortening time consumption, facilitating development and deployment of effects on the mobile terminal, and improving image processing efficiency.

According to the technical solution of the example of the disclosure, after the video frame to be processed is obtained and the target normal map of the video frame to be processed is determined, the target lighting intensity information of the at least one pixel of the video frame to be processed can be determined based on the target normal map and the preset attribute information of the light source. Then, the display information of the corresponding pixel is determined based on the target lighting intensity information of the at least one pixel, and the target video frame corresponding to the video frame to be processed is determined based on the display information. Thus, the problem that in the related art, a quality of a learning model obtained is poor due to that training samples are poor in quality and inconsistent, such that a normal map determined is inaccurate is solved. The problem that when the model is applied to the terminal device, a requirement for a performance of the terminal device is high, and determination of a normal map is low efficient and universality is poor is also improved. However, according to the technical solution, the normal estimation algorithm can be used to determine the normal map of the video frame to be processed. Then, the target lighting intensity information of the at least one pixel can be determined based on a relation between the light source corresponding to the effect and the at least one pixel in the normal diagram, and the corresponding pixel may be displayed conveniently based on the target lighting intensity information. Thus, the efficiency of determination of the normal diagram is improved, accuracy and universality of effect addition are further improved.

### Example 2

FIG. 4 is a schematic structural diagram of an apparatus of image processing according to Example 2 of the disclosure. As shown in FIG. 4, the apparatus includes: a normal map determination module 210, a lighting intensity determination module 220 and a target video frame display module 230.

The normal map determination module 210 is configured to obtain a video frame to be processed and determine a target normal map of the video frame to be processed. The lighting intensity determination module 220 is configured to determine, based on the target normal map and preset attribute information of a light source, target lighting intensity information of at least one pixel of the video frame to be processed. The target video frame display module 230 is configured to determine display information of the at least one pixel based on the target lighting intensity information of the at least one pixel, and determine, based on the display information, a target video frame corresponding to the video frame to be processed.

Based on the technical solution described above, the normal map determination module 210 includes:

a video frame obtainment unit configured to sequentially obtain at least one video frame to be processed from a target video; a normal information determination unit configured to determine gradient information, in a first direction and a second direction, of at least one pixel of the video frame to be processed to obtain normal information of the at least one pixel; and a normal map determination unit configured to obtain the target normal map based on the normal information of the at least one pixel.

Based on the technical solution described above, the normal map determination module 210 includes:

a to-be-segmented determination unit configured to obtain the video frame to be processed, and determine, based on a pre-trained image segmentation model, a target segmentation region corresponding to the video frame to be processed; and a normal map determination unit configured to determine gradient information, in a first direction and a second direction, of at least one pixel in the target segmentation region to obtain normal information of the at least one pixel, and determine, based on the normal information, the target normal map of the video frame to be processed.

Based on the technical solution described above, the normal information determination unit includes:
a to-be-used video frame determination sub-unit configured to filter, via joint bilateral filtering, the video frame to be processed to obtain a video frame to be used; and a normal information configuration sub-unit configured to determine, using a Sobel operator, gradient information, in the first direction and the second direction, of each pixel in the video frame to be used, and determine the normal information of the at least one pixel.

Based on the technical solution described above, the lighting intensity determination module 220 is further configured to determine, for each of the at least one pixel, target normal information corresponding to a current pixel in the target normal map, and determine target lighting intensity information of the current pixel based on the target normal information, the attribute information of the light source and shooting angle information of a video frame to which the current pixel belongs.

Based on the technical solution described above, the attribute information of the light source includes position information of the light source, and the lighting intensity determination module 220 further includes:
a lighting direction determination unit configured to determine light direction information of the current pixel based on the position information of the light source; a diffuse lighting value determination unit configured to determine a diffuse lighting value of the current pixel based on the light direction information, the target normal information and a preset diffuse coefficient; a reflection intensity value determination unit configured to determine a target reflection angle based on the light direction information and the target normal information, and determine a reflection intensity value of the current pixel based on the target reflection angle, the shooting angle information and a preset reflection coefficient; and a target lighting intensity determination unit configured to determine the target lighting intensity information based on the diffuse lighting value, the reflection intensity value, and an ambient lighting intensity value corresponding to the attribute information of the light source.

Based on the technical solution described above, the target lighting intensity determination unit is further configured to determine the target lighting intensity information as a maximum of the diffuse lighting value, the reflection intensity value and the ambient lighting intensity value.

Based on the technical solution described above, the target video frame display module 230 is further configured to determine display information of the at least one pixel based on the target lighting intensity information and corresponding pixel value information of the at least one pixel.

According to the technical solution of the example of the disclosure, after the video frame to be processed is obtained and the target normal map of the video frame to be processed is determined, the target lighting intensity information of the at least one pixel of the video frame to be processed can be determined based on the target normal map and the preset attribute information of the light source. Then, the display information of the corresponding pixel is determined based on the target lighting intensity information of the at least one pixel, and the target video frame corresponding to the video frame to be processed is determined based on the display information. Thus, the problem that in the related art, a quality of a learning model obtained is poor due to that training samples are poor in quality and inconsistent, such that a normal map determined is inaccurate is solved. The problem that when the model is applied to the terminal device, a requirement for a performance of the terminal device is high, and determination of a normal map is low efficient and universality is poor is also improved. However, according to the technical solution, the normal estimation algorithm can be used to determine the normal map of the video frame to be processed. Then, the target lighting intensity information of the at least one pixel can be determined based on a relation between the light source corresponding to the effect and the at least one pixel in the normal diagram, and the corresponding pixel may be displayed conveniently based on the target lighting intensity information. Thus, the efficiency of determination of the normal diagram is improved, accuracy and universality of effect addition are further improved.

The apparatus of image processing according to the example of the disclosure may execute the method of image processing according to any example of the disclosure, and has corresponding functional modules and effects for executing the method.

A plurality of units and modules included in the apparatus described above are merely divided based on a functional logic, but are not limited to the above division, as long as the corresponding functions can be performed. In addition, names of the plurality of functional unit are merely for the convenience of mutual distinguishing rather than limitation to the protection scope of the example of the disclosure.

### Example 3

FIG. 5 is a schematic structural diagram of an electronic device according to Example 3 of the disclosure. With reference to FIG. 5, a schematic structural diagram of the electronic device 300 (for example, a terminal device or a server in FIG. 5) applied to implementation of the example of the disclosure is shown. The terminal device in the example of the disclosure may include, but are not limited to, a mobile terminal such as a mobile phone, a laptop, a digital broadcast receiver, a personal digital assistant (PDA), a portable android device (PAD), a portable media player (PMP) and a vehicle-mounted terminal (such as a vehicle-mounted navigation terminal), and a fixed terminal such as a digital television (TV) and a desktop computer. The electronic device 300 shown in FIG. 5 is merely an instance, and should not be constructed as limitation to functions and application scopes of the example of the disclosure.

As shown in FIG. 5, the electronic device 300 may include a processing apparatus 301 (including a central processing unit, a graphics processing unit, etc.) that may execute various appropriate actions and processing based on a program stored in a read-only memory (ROM) 302 or a program loaded from a memory 308 to a random access memory (RAM) 303. The RAM 303 may further store various programs and data required for the operation by the electronic device 300. The processing apparatus 301, the ROM 302, and the RAM 303 are connected to one another through a bus 304. An input/output (I/O) interface 305 is also connected to the bus 304.

Generally, the following apparatuses may be connected to the I/O interface 305: an input apparatus 306 including, for example, a touch screen, a touch pad, a keyboard, a mouse, a camera, a microphone, an accelerometer and a gyroscope, an output apparatus 307 including, for example, a liquid crystal display (LCD), a speaker and a vibrator, the memory 308 including, for example, a magnetic tape and a hard disk, and a communication apparatus 309. The communication apparatus 309 may allow the electronic device 300 to be in wireless or wired communication with other devices for data exchange. Although the electronic device 300 having various apparatuses is shown in FIG. 5, not all the apparatuses shown are required to be implemented or provided. More or fewer apparatuses may be alternatively implemented or provided.

According to the example of the disclosure, a process described above with reference to the flowchart may be implemented as a computer software program. For example, the example of the disclosure includes a computer program product. The computer program product includes a computer program embodied on a non-transitory computer-readable medium, and the computer program includes program codes for implementing the method shown in the flowchart. In such an example, the computer program may be downloaded and installed from the network through the communication apparatus 309, or installed from the memory 308, or installed from the ROM 302. When executed by the processing apparatus 301, the computer program executes the above functions defined in the method according to the example of the disclosure.

Names of messages or information exchanged among a plurality of apparatuses in the embodiment of the disclosure are merely used for illustration rather than limitation to the scope of the messages or information.

The electronic device according to the example of the disclosure belongs to the same concept as the method of image processing according to the example described above, reference can be made to the example described above for the technical details not described in detail in this example, and this example has the same effects as the example described above.

### Example 4

An example of the disclosure provides a computer storage medium. The computer storage medium stores a computer program, where the computer program implements the method of image processing according to the example described above when executed by a processor.

The computer-readable medium described above of the disclosure may be a computer-readable signal medium or a computer-readable storage medium or their any combination. For example, the computer-readable storage medium may be, but are not limited to, an electric, magnetic, optical, electromagnetic, infrared, or semiconductor system, apparatus or device, or their any combination. Examples of the computer-readable storage medium may include, but are not limited to, an electrical connection with one or more wires, a portable computer disk, a hard disk, an RAM, an ROM, an erasable programmable read-only memory (EPROM or a flash memory), an optical fiber, a portable compact disc read-only memory (CD-ROM), an optical storage device, a magnetic storage device, or their any suitable combination. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is embodied. This propagated data signal may have a plurality of forms, including but not limited to an electromagnetic signal, an optical signal or their any suitable combination. The computer-readable signal medium may further be any computer-readable medium other than the computer-readable storage medium, and the computer-readable signal medium may send, propagate or transmit a program used by or in combination with the instruction execution system, apparatus or device. The program code included in the computer-readable medium may be transmitted by any suitable medium, including but not limited to: a wireless, wire, optical cable, radio frequency (RF) medium, etc., or their any suitable combination.

In some embodiments, a client and a server may communicate by using any network protocol such as the hypertext transfer protocol (HTTP) that is currently known or will be developed in future, and may be interconnected to digital data communication in any form or medium (for example, a communication network). Instances of the communication network include a local area network (LAN), a wide area network (WAN), Internet work (for example, the Internet), an end-to-end network (for example, an adhoc end-to-end network), and any network that is currently known or will be developed in future.

The computer-readable medium may be included in the electronic device, or exist independently without being fitted into the electronic device.

The computer-readable medium embodies one or more programs, and when executed by the electronic device, the one or more programs cause the electronic device to:
obtain a video frame to be processed and determine a target normal map of the video frame to be processed; determine, based on the target normal map and preset attribute information of a light source, target lighting intensity information of at least one pixel of the video frame to be processed; and determine display information of the at least one pixel based on the target lighting intensity information of the at least one pixel, and determine, based on the display information, a target video frame corresponding to the video frame to be processed.

Computer program codes for executing the operations of the disclosure may be written in one or more programming languages or their combinations, and the programming languages include, but are not limited to, object-oriented programming languages such as Java, Smalltalk and C++, and further include conventional procedural programming languages such as “C” language or similar programming languages. The program codes may be completely executed on a computer of a user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

The flowcharts and block diagrams in the accompanying drawings illustrate the architectures, functions and operations that may be implemented by the systems, the methods and the computer program products according to various examples of the disclosure. In this regard, each block in the flowchart or block diagram may represent one module, one program segment, or a part of codes that includes one or more executable instructions for implementing specified logical functions. It should also be noted that in some alternative implementations, the functions indicated in the blocks may occur in an order different than those indicated in the accompanying drawings. For example, two blocks indicated in succession may actually be executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The units involved in the example of the disclosure may be implemented by software or hardware. A name of the unit does not constitute limitation to the unit itself in one case. For example, a normal map determination module may also be described as “an image determination module”.

The functions described above herein may be executed at least in part by one or more hardware logic components. For example, usable hardware logic components of demonstration types include a field programmable gate array (FPGA), an application specific integrated circuit (ASIC), application specific standard parts (ASSP), a system on chip (SOC), a complex programmable logic device (CPLD), etc. in a non-restrictive way.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable medium may include, but is not limited to, an electric, magnetic, optical, electromagnetic, infrared, or semiconductor system, apparatus or device, or their any suitable combination. An instance of the machine-readable storage medium may include an electrical connection based on one or more wires, a portable computer disk, a hard disk, an RAM, an ROM, an EPROM or a flash memory, an optical fiber, a CD-ROM, an optical storage device, a magnetic storage device, or their any suitable combination.

According to one or more examples of the disclosure, [Instance 1] provides a method of image processing. The method includes:

A video frame to be processed is obtained and a target normal map of the video frame to be processed is determined.

Based on the target normal map and preset attribute information of a light source, target lighting intensity information of at least one pixel of the video frame to be processed is determined.

Display information of the at least one pixel is determined based on the target lighting intensity information of the at least one pixel, and based on the display information, a target video frame corresponding to the video frame to be processed is determined.

According to one or more examples of the disclosure, [Instance 2] provides the method of image processing. The method further includes:

The steps that a video frame to be processed is obtained and a target normal map of the video frame to be processed is determined include:

At least one video frame to be processed is sequentially obtained from a target video.

Gradient information, in a first direction and a second direction, of at least one pixel of the video frame to be processed are determined to obtain normal information of the at least one pixel is obtained.

The target normal map is obtained based on the normal information of the at least one pixel.

According to one or more examples of the disclosure, [Instance 3] provides the method of image processing. The method further includes:

The steps that a video frame to be processed is obtained and a target normal map of the video frame to be processed is determined include:

The video frame to be processed is obtained, and based on a pre-trained image segmentation model, a target segmentation region corresponding to the video frame to be processed is determined.

Gradient information, in a first direction and a second direction, of at least one pixel in the target segmentation region are determined to obtain normal information of the at least one pixel, and based on the normal information, the target normal map of the video frame to be processed is determined.

According to one or more example of the disclosure, [Instance 4] provides the method of image processing. The method further includes:

The step that gradient information, in a first direction and a second direction, of at least one pixel of the video frame to be processed are determined to obtain normal information of the at least one pixel includes:

The video frame to be processed is filtered via joint bilateral filtering to obtain a video frame to be used.

Gradient information, in the first direction and the second direction, of each pixel in the video frame to be used are determined using a Sobel operator, and the normal information of the at least one pixel is determined.

According to one or more examples of the disclosure, [Instance 5] provides the method of image processing. The method further includes:

The step that based on the target normal map and preset attribute information of a light source, target lighting intensity information of at least one pixel of the video frame to be processed is determined includes, for each of the at least one pixel:

Target normal information corresponding to a current pixel in the target normal map is determined, and target lighting intensity information of the current pixel is determined based on the target normal information, the attribute information of the light source and shooting angle information of a video frame to which the current pixel belongs.

According to one or more examples of the disclosure, [Instance 6] provides the method of image processing. The method further includes:

The attribute information of the light source includes position information of the light source, and the step that target lighting intensity information of the current pixel is determined based on the target normal information, the attribute information of the light source and shooting angle information of a video frame to which the current pixel belongs includes:

Light direction information of the current pixel is determined based on the position information of the light source.

A diffuse lighting value of the current pixel is determined based on the light direction information, the target normal information and a preset diffuse coefficient.

A target reflection angle is determined based on the light direction information and the target normal information, and a reflection intensity value of the current pixel is determined based on the target reflection angle, the shooting angle information and a preset reflection coefficient.

The target lighting intensity information is determined based on the diffuse lighting value, the reflection intensity value, and an ambient lighting intensity value corresponding to the attribute information of the light source.

According to one or more examples of the disclosure, [Instance 7] provides the method of image processing. The method further includes:

The step that the target lighting intensity information is determined based on the diffuse lighting value, the reflection intensity value, and an ambient lighting intensity value corresponding to the attribute information of the light source includes:

The target lighting intensity information is determined as a maximum of the diffuse lighting value, the reflection intensity value and the ambient lighting intensity value.

According to one or more examples of the disclosure, [Instance 8] provides the method of image processing. The method further includes:

The step that display information of the at least one pixel is determined based on the target lighting intensity information of the at least one pixel includes:

The display information of the at least one pixel is updated based on the target lighting intensity information and pixel value information of the at least one pixel.

According to one or more examples of the disclosure, [Instance 9] provides an apparatus of image processing. The apparatus includes:
a normal map determination module configured to obtain a video frame to be processed and determine a target normal map of the video frame to be processed;
a lighting intensity determination module configured to determine, based on the target normal map and preset attribute information of a light source, target lighting intensity information of at least one pixel of the video frame to be processed; and
a target video frame display module configured to determine display information of the at least one pixel based on the target lighting intensity information of the at least one pixel, and determine, based on the display information, a target video frame corresponding to the video frame to be processed.

In addition, although a plurality of operations are depicted in a particular order, it should not be understood that these operations are required to be executed in the particular order shown or in a sequential order. In certain circumstances, multi-task and parallel processing may be advantageous. Similarly, although a plurality of implementation details are included in the discussion described above, these details should not be construed as limitation to the scope of the disclosure. Some features described in the context of a separate example can be further implemented in a single example in a combination manner. On the contrary, various features described in the context of the single example can be further implemented in a plurality of examples separately or in any suitable sub-combination manner.

1. A method of image processing, the method comprising:
obtaining a video frame to be processed and determining a target normal map of the video frame to be processed;
determining, based on the target normal map and preset attribute information of a light source, target lighting intensity information of at least one pixel of the video frame to be processed; and
determining display information of the at least one pixel based on the target lighting intensity information of the at least one pixel, to determine, based on the display information, a target video frame corresponding to the video frame to be processed.

2. The method of claim 1, wherein obtaining the video frame to be processed and determining the target normal map of the video frame to be processed comprise:
sequentially obtaining at least one video frame to be processed from a target video;
determining gradient information, in a first direction and a second direction, of at least one pixel of the video frame to be processed to obtain normal information of the at least one pixel; and
obtaining the target normal map based on the normal information of the at least one pixel.

3. The method of claim 1, wherein obtaining the video frame to be processed and determining the target normal map of the video frame to be processed comprise:
obtaining the video frame to be processed, and determining, based on a pre-trained image segmentation model, a target segmentation region corresponding to the video frame to be processed; and
determining gradient information, in a first direction and a second direction, of at least one pixel in the target segmentation region to obtain normal information of the at least one pixel, and determining, based on the normal information, the target normal map of the video frame to be processed.

4. The method of claim 2, wherein determining the gradient information, in the first direction and the second direction, of the at least one pixel to obtain the normal information of the at least one pixel comprises:
filtering, via joint bilateral filtering, the video frame to be processed to obtain a video frame to be used; and
determining, using a Sobel operator, gradient information, in the first direction and the second direction, of each pixel in the video frame to be used, and determining the normal information of the at least one pixel.

5. The method of claim 1, wherein determining, based on the target normal map and the preset attribute information of the light source, the target lighting intensity information of at least one pixel of the video frame to be processed comprises, for each of the at least one pixel:
determining target normal information corresponding to a current pixel in the target normal map, and
determining target lighting intensity information of the current pixel based on the target normal information, the attribute information of the light source, and shooting angle information of a video frame to which the current pixel belongs.

6. The method of claim 5, wherein the attribute information of the light source comprises position information of the light source, and wherein determining the target lighting intensity information of the current pixel based on the target normal information, the attribute information of the light source, and the shooting angle information of a video frame to which the current pixel belongs comprises:
determining light direction information of the current pixel based on the position information of the light source;
determining a diffuse lighting value of the current pixel based on the light direction information, the target normal information, and a preset diffuse coefficient;
determining a target reflection angle based on the light direction information and the target normal information, and determining a reflection intensity value of the current pixel based on the target reflection angle, the shooting angle information and a preset reflection coefficient; and
determining the target lighting intensity information based on the diffuse lighting value, the reflection intensity value, and an ambient lighting intensity value corresponding to the attribute information of the light source.

7. The method of claim 6, wherein determining the target lighting intensity information based on the diffuse lighting value, the reflection intensity value, and an ambient lighting intensity value corresponding to the attribute information of the light source comprises:
determining the target lighting intensity information as a maximum value among the diffuse lighting value, the reflection intensity value, and the ambient lighting intensity value.

8. The method of claim 1, wherein determining the display information of the at least one pixel based on the target lighting intensity information of the at least one pixel comprises:
updating the display information of the at least one pixel based on the target lighting intensity information and pixel value information of the at least one pixel.

9. (canceled)

10. An electronic device, comprising:
at least one processor; and
a memory storing at least one program;
wherein the at least one processor, when executing the at least one program, is caused to implement a method comprising:
obtaining a video frame to be processed and determining a target normal map of the video frame to be processed;
determining, based on the target normal map and preset attribute information of a light source, target lighting intensity information of at least one pixel of the video frame to be processed; and
determining display information of the at least one pixel based on the target lighting intensity information of the at least one pixel, to determine, based on the display information, a target video frame corresponding to the video frame to be processed.

11. A non-transitory readable storage medium comprising computer-executable instructions which, when executed by a computer processor, implement a method comprising:
obtaining a video frame to be processed and determining a target normal map of the video frame to be processed;
determining, based on the target normal map and preset attribute information of a light source, target lighting intensity information of at least one pixel of the video frame to be processed; and
determining display information of the at least one pixel based on the target lighting intensity information of the at least one pixel, to determine, based on the display information, a target video frame corresponding to the video frame to be processed.

12. (canceled)

13. The electronic device of claim 10, wherein obtaining the video frame to be processed and determining the target normal map of the video frame to be processed comprise:
sequentially obtaining at least one video frame to be processed from a target video;
determining gradient information, in a first direction and a second direction, of at least one pixel of the video frame to be processed to obtain normal information of the at least one pixel; and
obtaining the target normal map based on the normal information of the at least one pixel.

14. The electronic device of claim 1, wherein obtaining the video frame to be processed and determining the target normal map of the video frame to be processed comprise:
obtaining the video frame to be processed, and determining, based on a pre-trained image segmentation model, a target segmentation region corresponding to the video frame to be processed; and
determining gradient information, in a first direction and a second direction, of at least one pixel in the target segmentation region to obtain normal information of the at least one pixel, and determining, based on the normal information, the target normal map of the video frame to be processed.

15. The electronic device of claim 13, wherein determining the gradient information, in the first direction and the second direction, of the at least one pixel to obtain the normal information of the at least one pixel comprises:
filtering, via joint bilateral filtering, the video frame to be processed to obtain a video frame to be used; and
determining, using a Sobel operator, gradient information, in the first direction and the second direction, of each pixel in the video frame to be used, and determining the normal information of the at least one pixel.

16. The electronic device of claim 10, wherein determining, based on the target normal map and the preset attribute information of the light source, the target lighting intensity information of at least one pixel of the video frame to be processed comprises, for each of the at least one pixel:
determining target normal information corresponding to a current pixel in the target normal map, and
determining target lighting intensity information of the current pixel based on the target normal information, the attribute information of the light source, and shooting angle information of a video frame to which the current pixel belongs.

17. The electronic device of claim 16, wherein the attribute information of the light source comprises position information of the light source, and wherein determining the target lighting intensity information of the current pixel based on the target normal information, the attribute information of the light source, and the shooting angle information of a video frame to which the current pixel belongs comprises:
determining light direction information of the current pixel based on the position information of the light source;
determining a diffuse lighting value of the current pixel based on the light direction information, the target normal information, and a preset diffuse coefficient;
determining a target reflection angle based on the light direction information and the target normal information, and determining a reflection intensity value of the current pixel based on the target reflection angle, the shooting angle information and a preset reflection coefficient; and
determining the target lighting intensity information based on the diffuse lighting value, the reflection intensity value, and an ambient lighting intensity value corresponding to the attribute information of the light source.

18. The electronic device of claim 17, wherein determining the target lighting intensity information based on the diffuse lighting value, the reflection intensity value, and an ambient lighting intensity value corresponding to the attribute information of the light source comprises:
determining the target lighting intensity information as a maximum value among the diffuse lighting value, the reflection intensity value, and the ambient lighting intensity value.

19. The electronic device of claim 10, wherein determining the display information of the at least one pixel based on the target lighting intensity information of the at least one pixel comprises:
updating the display information of the at least one pixel based on the target lighting intensity information and pixel value information of the at least one pixel.

20. The non-transitory readable storage medium of claim 11, wherein obtaining the video frame to be processed and determining the target normal map of the video frame to be processed comprise:
sequentially obtaining at least one video frame to be processed from a target video;
determining gradient information, in a first direction and a second direction, of at least one pixel of the video frame to be processed to obtain normal information of the at least one pixel; and
obtaining the target normal map based on the normal information of the at least one pixel.

21. The non-transitory readable storage medium of claim 11, wherein obtaining the video frame to be processed and determining the target normal map of the video frame to be processed comprise:
obtaining the video frame to be processed, and determining, based on a pre-trained image segmentation model, a target segmentation region corresponding to the video frame to be processed; and
determining gradient information, in a first direction and a second direction, of at least one pixel in the target segmentation region to obtain normal information of the at least one pixel, and determining, based on the normal information, the target normal map of the video frame to be processed.

22. The non-transitory readable storage medium of claim 20, wherein determining the gradient information, in the first direction and the second direction, of the at least one pixel to obtain the normal information of the at least one pixel comprises:
filtering, via joint bilateral filtering, the video frame to be processed to obtain a video frame to be used; and
determining, using a Sobel operator, gradient information, in the first direction and the second direction, of each pixel in the video frame to be used, and determining the normal information of the at least one pixel.
